(19) United States
(12) Patent Application Publication
(10) Pub. No.: US 2026/0098985 A1
(43) Pub. Date: Apr. 9, 2026

(54) TOUCH ASSEMBLY

(71) Applicant: TPK Glass Solutions (Xiamen) Inc., Xiamen (CN)

(72) Inventors: Li Huang Tsai, Miaoli County (TW); Chien Min Lai, Taipei City (TW); Liang Liu, Xiamen City (CN); Zhi Jun She, Xiamen City (CN)

(21) Appl. No.: 19/305,964

(22) Filed: Aug. 21, 2025

(30) Foreign Application Priority Data
Oct. 8, 2024 (CN) 202411396488.4

(51) Int. Cl. G02B 1/11; G02B 5/30; G06F 3/044; G06F 3/047

(52) U.S. Cl. CPC G02B 1/11; G02B 5/3033; G02B 5/3083; G06F 3/0443; G06F 3/0446; G06F 3/047; G06F 2203/04103; G06F 2203/04111

(57) ABSTRACT

A touch assembly includes a protective cover plate, a first adhesive layer, a wire layer, a second adhesive layer, and a visual effect improvement structure. The first adhesive layer is disposed on the protective cover. The thickness of the first adhesive layer ranges from 20 µm to 200 µm. The wire layer comprises curved wires disposed on the first adhesive layer. The curved wires comprise a first group of wires extending along a first direction and a second group of wires extending along a second direction and overlapping the first group of wires. Each of the curved wires comprises a conductive inner core and a covering layer. The second adhesive layer covers the curved wires and the first adhesive layer. The visual effect improvement structure corresponds to each of the curved wires in a stacking direction of the protective cover plate and the wire layer.

### CROSS-REFERENCE TO RELATED APPLICATION

This application claims priority to China Patent Application 202411396488.4, filed October 8, 2024, which is incorporated herein by reference.

### FIELD OF DISCLOSURE

The present disclosure relates to a touch assembly and the manufacturing method thereof.

### DESCRIPTION OF RELATED ART

As diversified developments of touch modules progress, touch modules have been maturely implemented in industrial electronic and consumer products. It gradually has become more and more common to have various touch products embedded in medium and large-scale products.

However, the manufacturing process of the touch modules of the prior art uses indium tin oxide (ITO) as transparent electrodes. To produce ITO, rare metal indium is required. The reserves of indium are limited, and the mining process thereof creates environmental pollution, as well as a vast amount of indium tin (IT) requires oxygen (O) waste during the manufacturing process of the prior art. These wastes need to be handled properly to prevent environment pollution. In addition, the aforementioned prior art requires high temperature, high pressure, and vacuum deposition equipment that consumes high energy.

Therefore, to introduce a touch assembly and the manufacturing method thereof that can solve the aforementioned problems is what the industry invests its research and development resources in and intends to achieve.

### SUMMARY OF THE DISCLOSURE

In view of the foregoing statement, the objective of the present disclosure is to provide a touch assembly and the manufacturing method thereof that can solve the aforementioned problems.

To achieve the aforementioned objective, according to one of the embodiments of the present disclosure, a touch assembly comprises a protective cover plate, a first adhesive layer, a wire layer, a second adhesive layer, and a visual effect improvement structure. The first adhesive layer is disposed on the protective cover plate, and a thickness of the first adhesive layer is from 20 µm to 200 µm. The wire layer comprises curved wires disposed on the first adhesive layer. The curved wires comprise a first group of wires extending along a first direction and a second group of wires extending along a second direction and overlapping the first group of wires. Each of the curved wires comprises a conductive inner core and a covering layer. The second adhesive layer covers the curved wires and the first adhesive layer. The visual effect improvement structure corresponds to each of the curved wires in a stacking direction of the protective cover plate and the wire layer.

In one or several embodiments of the present disclosure, the visual effect improvement structure is an anti-glare coating (AR) layer disposed on the protective cover plate.

In one or several embodiments of the present disclosure, the visual effect improvement structure comprises a polarizing plate.

In one or several embodiments of the present disclosure, the visual effect improvement structure is stacked on one side of the wire layer close to the protective cover plate.

In one or several embodiments of the present disclosure, the visual effect improvement structure is stacked on one side of the wire layer away from the protective cover plate.

In one or several embodiments of the present disclosure, the visual effect improvement structure further comprises a retarder film, disposed on the polarizing plate.

In one or several embodiments of the present disclosure, each of the curved wires is an enameled wire.

In one or several embodiments of the present disclosure, the visual effect improvement structure comprises a polarizing layer. The polarizing layer is coated outside the covering layer of each of the curved wires.

In one or several embodiments of the present disclosure, the visual effect improvement structure further comprises a retarder film. The retarder film is coated outside the covering layer of each of the curved wires. The polarizing layer is coated outside the retarder film.

In one or several embodiments of the present disclosure, the material of the covering layer is selected from the group consisting of polyvinyl formal, polyurethane (PU), polyamide (PA), polyester, polyester-polyimide (PI), polyamide-polyimide, polyimide, and a combination thereof.

In summary, for the touch assembly of the present disclosure, due to the fact that each of the curved wires is a wire having a conductive inner core and a covering layer, winding technology is used during the touch assembly production so that problems of high pollution and high energy consumption that occur during the complex production process of the prior art, which uses indium tin oxide (ITO) as transparent electrodes, can be prevented. By means of having the curved wires disposed between the first adhesive layer and the second adhesive layer, gaps among the curved wires can be filled by the first adhesive layer and the second adhesive layer. As a result, the visual sense of seeing the curved wires from one side of the second adhesive layer is reduced effectively (that is, reducing the generation of shadows). By having the visual effect improvement structure configured for each of the corresponding curved wires in the touch assembly, the visual sense of seeing mesh patterns in the touch assembly in an environment of high brightness can be effectively resolved.

The aforementioned statements are used for explaining the problems that can be solved by the present disclosure, the technical means for solving the problems, and the effect thereof. The present disclosure will become more fully understood from the detailed descriptions given herein below by way of embodiments with reference to the accompanying drawings for illustration only.

### BRIEF DESCRIPTION OF THE DRAWINGS

To better understand the aforementioned and other objectives, novel features, advantages, embodiments, and the effect of the present disclosure, diagrams are provided as follows:

FIG. 1 is a schematic diagram of the touch assembly according to an embodiment of the present disclosure.

FIG. 2 is a partial cross-sectional schematic diagram of some elements of FIG. 1.

FIG. 3 is a flowchart of the manufacturing method of the touch assembly according to an embodiment of the present disclosure.

FIG. 4 is a flowchart of the manufacturing method of the touch assembly according to another embodiment of the present disclosure.

FIG. 5A to FIG. 5J are the schematic diagrams of, respectively, the intermediate steps of the manufacturing method of the touch assembly according to an embodiment of the present disclosure.

FIG. 6 is a partial cross-sectional schematic diagram of FIG. 5I.

FIG. 7A to FIG. 7H are the schematic diagrams of, respectively, the intermediate steps of the manufacturing method of the touch assembly according to an embodiment of the present disclosure.

FIG. 8 is a schematic diagram of the touch assembly according to another embodiment of the present disclosure.

FIG. 9 is a schematic diagram of the touch assembly according to another embodiment of the present disclosure.

FIG. 10 is a schematic diagram of the touch assembly according to another embodiment of the present disclosure.

FIG. 11 is a schematic diagram of the touch assembly according to another embodiment of the present disclosure.

FIG. 12 is a schematic diagram of the touch assembly according to another embodiment of the present disclosure.

FIG. 13 is a cross-sectional schematic diagram of the curved wire and the visual effect improvement structure according to an embodiment of the present disclosure.

### DETAILED DESCRIPTION OF THE PREFERRED EMBODIMENTS

A plurality of embodiments of the present disclosure will be disclosed below with reference to drawings. For the purpose of clear illustration, many details in practice will be provided together with the following descriptions. However, these detailed descriptions in practice are for illustration only and shall not be interpreted to limit the scope, applicability, or configuration of the present disclosure in any way. That is, in some embodiments of the present disclosure, these details in practice are not required. Furthermore, for the purpose of simplifying drawings, some structures and components of the prior art shown in the drawings will be illustrated schematically.

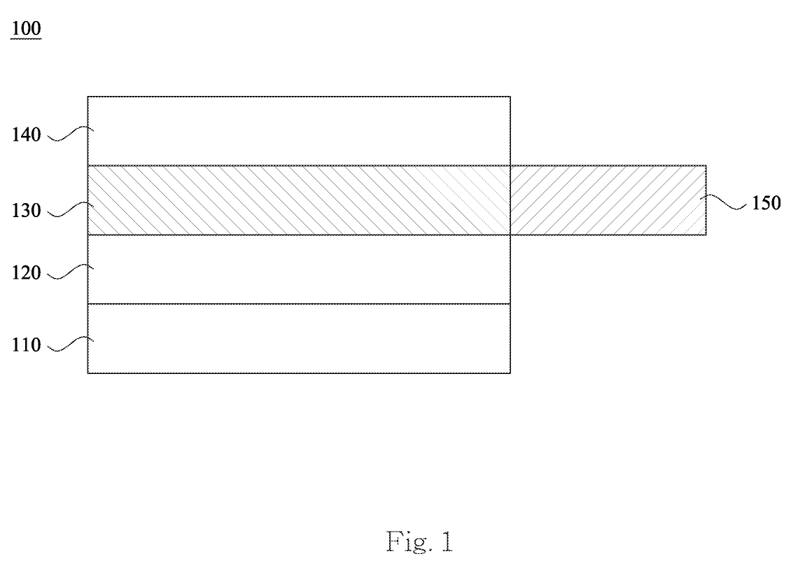

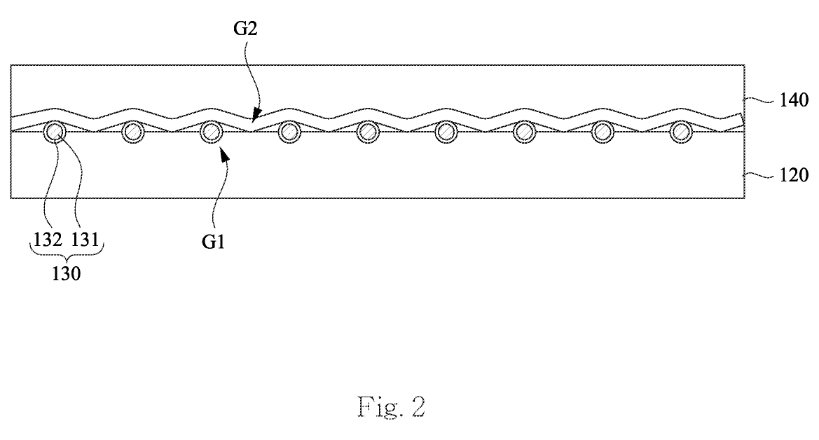

Please refer to FIG. 1 and FIG. 2. FIG. 1 is a schematic diagram of the touch assembly 100 according to an embodiment of the present disclosure. FIG. 2 is a partial cross-sectional schematic diagram of some elements of FIG. 1. In the embodiment, as illustrated in FIG. 1 and FIG. 2, the touch assembly 100 comprises a protective cover plate 110, a first adhesive layer 120, a plurality of curved wires 130, a second adhesive layer 140, and a circuit board 150. The first adhesive layer 120 is disposed on the protective cover plate 110. The curved wire 130 is disposed on the first adhesive layer 120 and comprises a first group of wires G1 and a second group of wires G2. The first group of wires G1 extends along a first direction and is arranged apart from each other. The second group of wires G2 extends along a second direction, overlaps with the first group of wires G1, and is arranged apart from each other. In some embodiments, the first direction and the second direction are perpendicular to each other, for example, the directions of the X-axis and Y-axis. The second adhesive layer 140 covers the curved wires 130 and the first adhesive layer 120. The circuit board 150 and the curved wires 130 are electrically connected. The circuit board 150 is, for example, a flexible printed circuit board; however, the present disclosure is not limited thereto.

More specifically, as shown in FIG. 2, each curved wire 130 comprises a conductive inner core 131 and a covering layer 132. The covering layer 132 is composed of insulation materials. Therefore, the conductive inner cores 131 of the first group of wires G1 and the second group of wires G2 are electrically insulated, respectively, through the covering layers 132 of the first group of wires G1 and the second group of wires G2. Hereby, touch signals (for example, mutual capacitive sensing signals) between the first group of wires G1 and the second group of wires G2 can be drawn to the circuit board 150.

In the embodiment, every curved wire 130 is an enameled wire. Therefore, curved wires 130 can be produced by the winding technology in the touch assembly 100 so as to prevent the problems of high pollution and high energy consumption from occurring during the complex production process of the prior art, which uses indium tin oxide (ITO) as transparent electrodes.

During practical implementation, the curved wires 130 can also be a combination of enameled wire and transparent electrodes of indium tin oxide (ITO). For example, one group in the first group of wires G1 and the second group of wires G2 of the curved wires 130 consists of enameled wires, while the other group in the first group of wires G1 and the second group of wires G2 consists of transparent electrodes of indium tin oxide.

In one or several embodiments, the material of the conductive inner core 131 of the curved wire 130 comprises silver, copper, aluminum, tungsten, or similar metals.

In one or several embodiments, the material of the conductive inner core 131 of the curved wire 130 comprises palladium copper alloy, silver copper palladium alloy, molybdenum rhenium alloy, aluminum alloy, nickel alloy, or similar alloys.

In this embodiment, the thickness of the first adhesive layer 120 is from 20 µm to 200 µm. The initial tack of the first adhesive layer 120 is from 1800 gf/in to 4000 gf/in. One thing to be noted is that when the hardness of the curved wire 130 is relatively high (for example, the material of the conductive inner core 131 of the curved wire 130 is alloy), the curved wire 130 wound on the first adhesive layer 120 can easily generate breaking away stress, resulting in a jump wire problem. By limiting the thickness and initial tack of the first adhesive layer 120 within the aforementioned specific range, the issue of the curved wire 130 jumping relative to the first adhesive layer 120 during the winding process can be effectively prevented. More specifically, when either the thickness or the initial tack of the first adhesive layer 120 is smaller than the lower limit of the aforementioned range, the jump wire problem easily happens. When the thickness of the first adhesive layer 120 is larger than the upper limit of the aforementioned range, it will lead to an increase in the overall volume, weight, and cost of the touch assembly 100 and become a problem. When the initial tack of the first adhesive layer 120 is greater than the upper limit of the aforementioned range, not only is the selection of materials limited, but the workability will also drop.

In one or several embodiments, the material of the covering layer 132 of the curved wire 130 is composed of polyvinyl formal, polyurethane, polyamide, polyester, polyester-polyimide, polyamide-polyimide, or polyimide; however, the present disclosure is not limited thereto.

In one or several embodiments, the wire diameter of the conductive inner core 131 of the curved wire 130 is from 2 µm to 20 µm. Preferably, the wire diameter of the conductive inner core 131 is from 2 µm to 5 µm in order to increase the visibility of the touch assembly 100, in other words, to reduce the visual sense of the curved wire 130. In several embodiments, the thickness of the covering layer 132 of the curved wire 130 is from 1 µm to 3 µm. For example, in one embodiment, the wire diameter of the conductive inner core 131 is around 5 µm, whereas the thickness of the covering layer 132 is around 2 µm (that is, the wire diameter of the curved wire is around 7 µm); however, the present disclosure is not limited thereto.

In the embodiment, as shown in FIG. 2, the first adhesive layer 120 and the second adhesive layer 140 fill the gaps within the first group of wires and the gaps within the second group of wires. Therefore, gaps between the curved wires 130 and the first adhesive layer 120 and the second adhesive layer 140 caused by indentation can be eliminated. As a result, the visual sense of seeing the curved wires 130 from one side of the second adhesive layer 140 can be reduced effectively (that is, reducing the generation of shadows).

In one or several embodiments, at least one of the first adhesive layer 120 or the second adhesive layer 140 is an optical clear adhesive (OCA) layer or a liquid optical clear adhesive (LOCA) layer; however, the present disclosure is not limited thereto.

In one or several embodiments, the thickness of the second adhesive layer 140 is from 25 µm to 150 µm. When the thickness of the second adhesive layer 140 is smaller than the aforementioned lower limit, the aforementioned gaps will not be easily removed. When the thickness of the second adhesive layer 140 is larger than the aforementioned upper limit, it will lead to the increase of the overall volume, weight, and cost of the touch assembly 100.

Please refer to FIG. 3, which is a flowchart of the manufacturing method of the touch assembly according to an embodiment of the present disclosure. In the embodiment, as shown in FIG. 3 in conjunction with FIG. 1 and FIG. 2, the manufacturing method of the touch assembly comprises Steps S110 to S140.

Step S110: Laminate the first adhesive layer 120 on the protective cover plate 110 tightly.

In one or several embodiments, Step S110 is to continuously laminate the first adhesive layer 120 onto the protective cover plate 110 at about 130 degrees Celsius for about 40 minutes; however, the present disclosure is not limited thereto.

In one or several embodiments, prior to Step S110, a process to form a black matrix (BM) layer on the protective cover plate 110 is carried out. After Step S110 is implemented, the first adhesive layer 120 will be in contact with the black matrix layer.

Step S120: Place a plurality of curved wires 130 on the first adhesive layer 120.

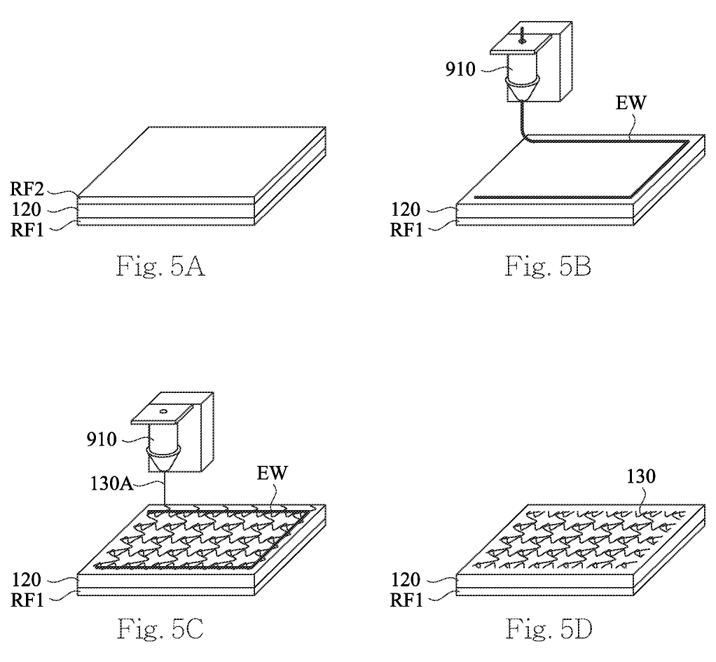

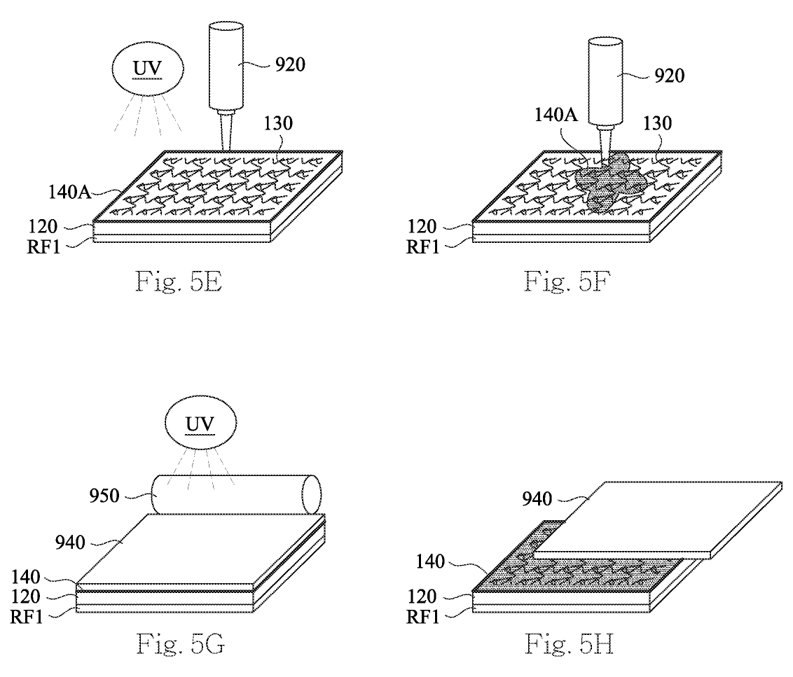

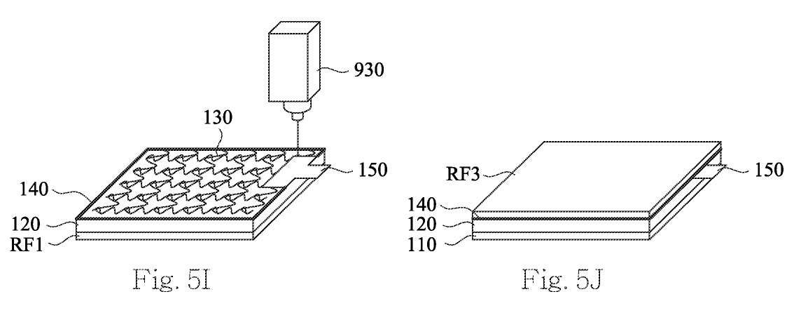

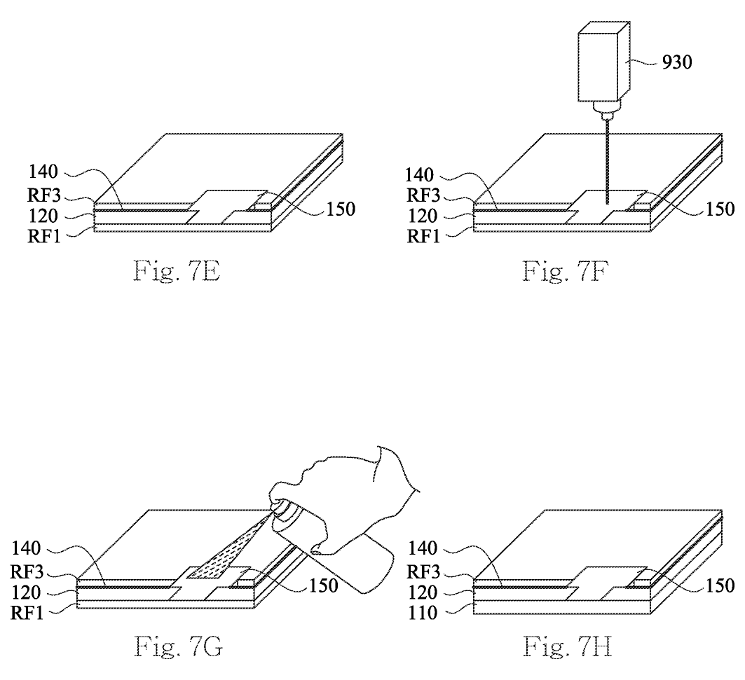

In one or several embodiments, Step S120 comprises: winding enameled wire 130A (in reference to FIG. 5C and FIG. 7B) onto the first adhesive layer 120; and cutting the enameled wire 130A to form the curved wires 130.

In one or several embodiments, the step of cutting the enameled wire 130A to form the curved wires 130 is carried out through a laser cutting process; however, the present disclosure is not limited thereto.

Step S130: Put the second adhesive layer 140 over the curved wires 130 and the first adhesive layer 120.

In one or several embodiments, Step S130 is to continuously laminate the second adhesive layer 140 onto the first adhesive layer 120 at about 130 degrees Celsius for about 40 minutes; however, the present disclosure is not limited thereto.

Step S140: Weld the circuit boards 150 to the curved wires 130.

In one or several embodiments, Step S140 is carried out through a laser welding process; however, the present disclosure is not limited thereto.

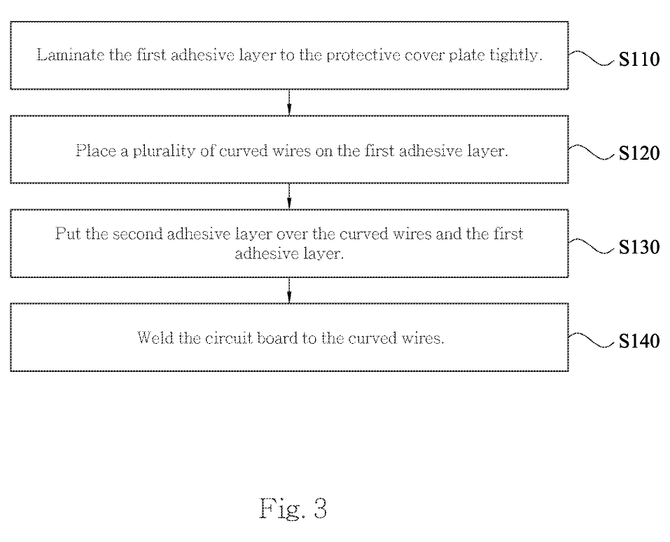

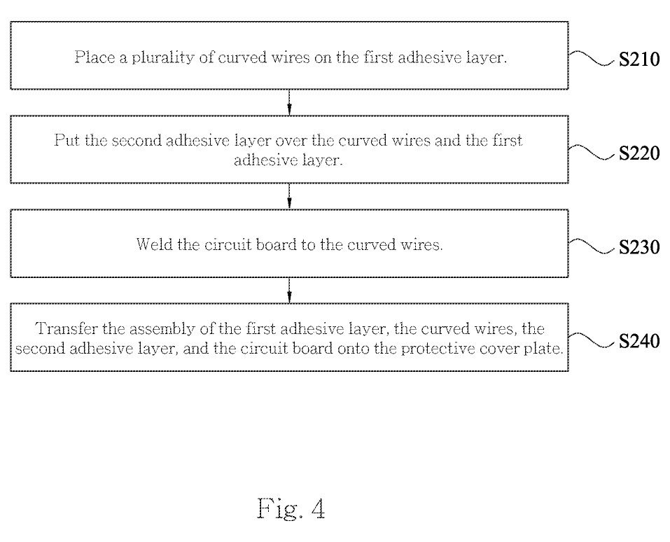

Please refer to FIG. 4. FIG. 4 is a flowchart of the manufacturing method of the touch assembly according to another embodiment of the present disclosure. In the embodiment, as shown in FIG. 4 in conjunction with FIG. 1 and FIG. 2, the manufacturing method of the touch assembly comprises Steps S210 to S240.

Step S210: Place a plurality of curved wires 130 on the first adhesive layer 120.

In one or several embodiments, Step S210 comprises: Winding enameled wire 130A (in reference to FIG. 5C and FIG. 7B) onto the first adhesive layer 120; and cutting the enameled wire 130A to form the curved wires 130.

Step S220: Put the second adhesive layer 140 over the curved wires 130 and the first adhesive layer 120.

In one or several embodiments, Step S220 is to continuously laminate the second adhesive layer 140 onto the first adhesive layer 120 at about 130 degrees Celsius for about 40 minutes. However, the present disclosure is not limited thereto.

Step S230: Weld the circuit board 150 to the curved wires 130.

In one or several embodiments, Step S230 is carried out through a laser welding process; however, the present disclosure is not limited thereto.

Step S240: Transfer the assembly of the first adhesive layer 120, the curved wires 130, the second adhesive layer 140, and the circuit board 150 onto the protective cover plate 110.

In comparison to the embodiment shown in FIG. 3, the embodiment illustrated in FIG. 4 transfers the assembly of the first adhesive layer 120, the curved wires 130, and the second adhesive layer 140 onto the protective cover plate 110 after the laminating process of the second adhesive layer 140, so that the problem of damaging the black matrix layer on the protective cover plate 110 caused by the high temperature during the laminating process can be effectively prevented.

Please refer to FIG. 5A to FIG. 5J. FIG. 5A to FIG. 5J are the schematic diagrams of, respectively, the intermediate steps of the manufacturing method of the touch assembly according to an embodiment of the present disclosure. The embodiment is one specific embodiment of the manufacturing method illustrated in FIG. 4, and descriptions are provided as follows.

In the step illustrated in FIG. 5A, both the surfaces of the first adhesive layer 120, opposite to each other, are laminated with separation films RF1, RF2 respectively.

As shown in FIG. 5B, this step follows the step shown in FIG. 5A. In this step, the separation film RF2 is peeled off; then a pre-embedded wire EW is disposed on the surface of the first adhesive layer 120 that was originally laminated with the separation film RF2. The pre-embedded wire EW is wound on the first adhesive layer 120 by a winding machine 910. The pre-embedded wire EW has a U-shape after the winding process, as shown in FIG. 5B; however, the present disclosure is not limited thereto.

As shown in FIG. 5C, this step follows the step shown in FIG. 5B. In this step, the enameled wire 130A is wound on the first adhesive layer 120. The winding method is, for example, to wind the wire back and forth and around along a route on the first adhesive layer 120, so that the enameled wire 130A partially covers the pre-embedded wire EW. Specifically, as shown in FIG. 5C, the enameled wire 130A is disposed on the first adhesive layer 120 in a checkerboard pattern, and three edges of the checkerboard pattern overlap the pre-embedded wire EW.

As shown in FIG. 5D, this step follows the step shown in FIG. 5C. In this step, a single enameled wire 130A is cut to form a plurality of curved wires 130. Specifically, this step can cause the enameled wire 130A to break up and form curved wires 130 through the action of peeling the pre-embedded wire EW from the first adhesive layer 120. The mechanism of peeling the pre-embedded wire EW to cause the enameled wire 130A to break up is similar to the action of pulling tear tape on cellophane of a cigarette pack. In comparison to a method that uses a cutter to cut the enameled wire 130A, the present step will not leave tool marks on the first adhesive layer 120. Therefore, Step S210 can be carried out by executing steps illustrated in FIG. 5B, FIG. 5C, and FIG. 5D in sequence.

In one or several embodiments, the wire diameter of the pre-embedded wire EW is larger than the wire diameter of the enameled wire 130A. Hereby, the larger pre-embedded wire EW has higher tensile strength than that of the thinner enameled wire 130A, so that during the process of peeling the pre-embedded wire EW, which forces the enameled wire 130A to break up, the pre-embedded wire EW will also not break apart. In one embodiment, the wire diameter of the pre-embedded wire EW is around 20 µm, and the wire diameter of the enameled wire 130A is around 5 µm. However, the present disclosure is not limited thereto.

As shown in FIG. 5E, this step follows the step shown in FIG. 5D. In this step, a hydrogel 140A is coated on the first adhesive layer 120 using a glue spreader 920. Specifically, the hydrogel 140A is coated on an outer edge of the first adhesive layer 120. In several embodiments, the hydrogel 140A is a type of light-curing adhesive. For example, the light-curing adhesive is hardened after being exposed to ultraviolet (UV) light. Hereby, when light exposure also occurs during this step, the hydrogel 140A coated on the outer edge of the first adhesive layer 120 is hardened and becomes an outer wall.

As shown in FIG. 5F, this step follows the step shown in FIG. 5E. In this step, the hydrogel 140A is further coated over the first adhesive layer 120 using a glue spreader 920 in order to cover the curved wires 130. In other words, the hydrogel 140A is coated over and fills in the space within the aforementioned outer wall in this step. In other embodiments, this step can also use methods of scraping, dispensing, slitting, filling, or similar coating methods.

As shown in FIG. 5G, this step follows the step shown in FIG. 5F. In this step, a plate 940 is placed on and covers the hydrogel 140A, and the plate 940 is rolled using a roller 950. Hereby, when light exposure also occurs during this step, the hydrogel 140A is hardened into the second adhesive layer 140 of uniform thickness.

As shown in FIG. 5H, this step follows the step shown in FIG. 5G. In this step, after the hydrogel 140A is hardened into the second adhesive layer 140, the plate 940 can be removed. Therefore, step S220 can be carried out by executing steps illustrated in FIG. 5E, FIG. 5F, FIG. 5G, and FIG. 5H in sequence.

As shown in FIG. 5I, this step follows the step shown in FIG. 5H. In this step, the circuit board 150 is welded to the curved wires 130 (that is, step S230).

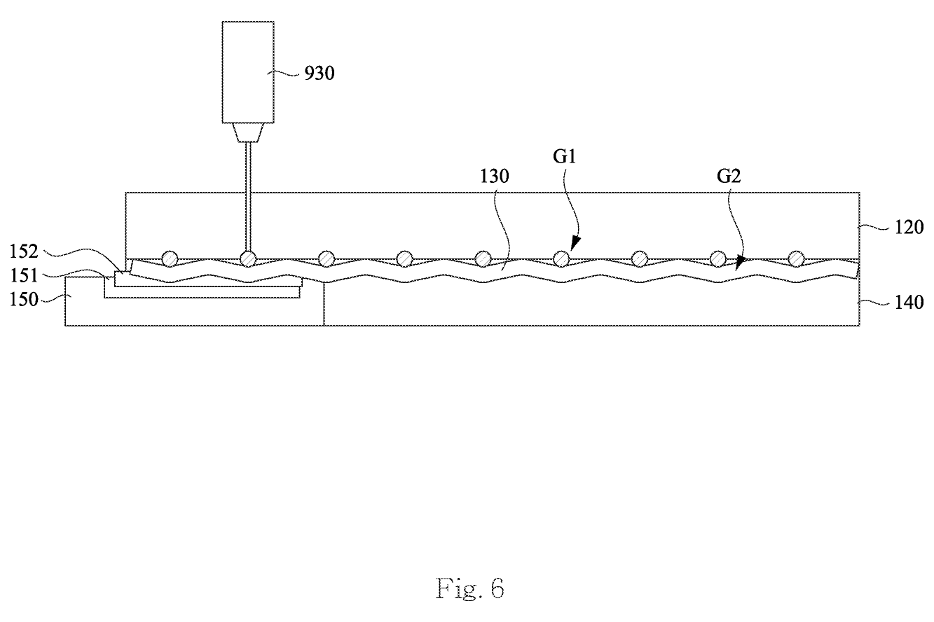

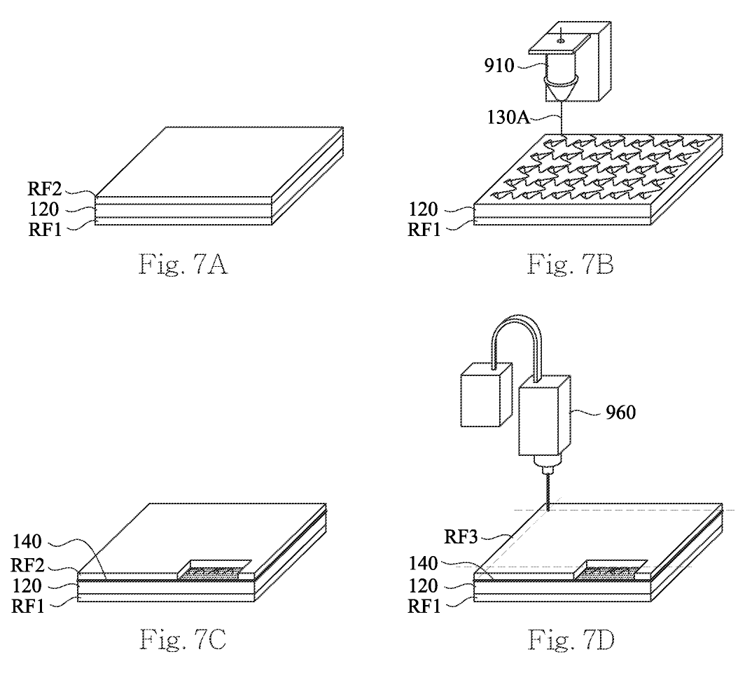

Please refer to FIG. 6, which is a partial cross-sectional schematic diagram of FIG. 5I. As shown in FIG. 6, the circuit board 150 is welded to the curved wires 130 using a welding machine 930. The circuit board 150 has a bonding pad 151 disposed thereon. The bonding pad 151 has a metal layer 152 disposed thereon. For example, materials of the metal layer 152 comprise tin; however, the present disclosure is not limited thereto. For example, the welding machine 930 is a laser welding machine. Laser can penetrate the first adhesive layer 120 and the second adhesive layer 140 and hit the curved wires 130, which are in contact with the metal layer 152. In several embodiments, the melting point of the covering layer 132 of the curved wire 130 is lower than the melting point of the metal layer 152. Therefore, the high temperature created by the laser causes the covering layer 132 to vaporize so that the conductive inner core 131 of the curved wire 130 is exposed. Then, the metal layer 152 is melted and welded to the conductive inner core 131.

As shown in FIG. 5J, this step follows the step shown in FIG. 5I. In this step, the assembly of the first adhesive layer 120, the curved wires 130, the second adhesive layer 140, and the circuit board 150 is transferred onto the protective cover plate 110 (that is, Step S240). In the embodiment shown in FIG. 5J, the aforementioned assembly has the separation film RF1 peeled off and then is transferred onto the protective cover plate 110, having the first adhesive layer 120 attached thereto. In addition, in this step, the separation film RF3 is attached to the second adhesive layer 140 to protect the second adhesive layer 140.

Please refer to FIG. 7A to FIG. 7H. FIG. 7A to FIG. 7H are the schematic diagrams of, respectively, the intermediate steps of the manufacturing method of the touch assembly according to an embodiment of the present disclosure. This embodiment is one specific embodiment of the manufacturing method illustrated in FIG. 4, and descriptions are provided as follows.

In this step, as shown in FIG. 7A, both the surfaces of the first adhesive layer 120, opposite to each other, are laminated with the separation films RF1, RF2 respectively.

As shown in FIG. 7B, this step follows the step shown in FIG. 7A. In this step, the separation film RF2 is peeled off and then the enameled wire 130A is wound on the first adhesive layer 120. The winding method is, for example, to wind the wire back and forth and around along a route on the first adhesive layer 120. Specifically, as shown in FIG. 7B, the enameled wire 130A is disposed on the first adhesive layer 120 in a checkerboard pattern.

As shown in FIG. 7C, this step follows the step shown in FIG. 7B. In this step, the second adhesive layer 140 having the separation film RF3 is adhered to the first adhesive layer 120. More specifically, the second adhesive layer 140 is adhered to the first adhesive layer 120 on the side away from the separation film RF3 to cover the first adhesive layer 120 and the enameled wire 130A. In other words, the assembly of the first adhesive layer 120, the enameled wire 130A, and the second adhesive layer 140 is stacked between the separation film RF1 and the separation film RF3. In comparison with the second adhesive layer 140 shown in FIG. 5H, which is formed by hardening the hydrogel 140A, the second adhesive layer 140 in this step is formed by a sheet of gel.

As shown in FIG. 7D, this step follows the step shown in FIG. 7C. In this step, the enameled wire 130A is cut to form a plurality of curved wires 130 using a slitter 960. For example, the slitter 960 is a laser slitter. When the enameled wire 130A is cut by laser to form curved wires 130 (that is, loop cutting), the first adhesive layer 120, the second adhesive layer 140, and the separation films RF1 and RF3 are cut by laser at the same time (that is, shape cutting). In comparison with the method of cutting the enameled wire 130A using cutlery, this step will not have the problem of pulling gel at an edge of the cutting area of the separation films RF1 and RF3. Therefore, steps S210 and S220 can be carried out simultaneously by executing the steps illustrated in FIG. 7B, FIG. 7C, and FIG. 7D in sequence.

In one or several embodiments, the laser used in the slitter 960 is a picosecond laser, a femtosecond laser, a CO₂ laser or similar light sources. However, the present disclosure is not limited thereto.

As shown in FIG. 7E, this step follows the step shown in FIG. 7D. In this step, the circuit board 150 and an area of the second adhesive layer 140, exposed from the separation film RF3, undergo alignment so that the circuit board 150 is in contact with the second adhesive layer 140.

As shown in FIG. 7F, this step follows the step shown in FIG. 7E. In this step, the circuit board 150 is welded to the curved wires 130 by the welding machine 930. Relevant explanations of the welding process can be referenced with respect to FIG. 6 and the aforementioned descriptions and will not be repeated. Therefore, Step S230 can be carried out by executing the steps illustrated in FIG. 7E and FIG. 7F in sequence.

As shown in FIG. 7G, this step follows the step shown in FIG. 7F. In this step, the circuit board 150 can be coated with protection paint after welding. Protection paint is, for example, three anti-glue; however, the present disclosure is not limited thereto. In several embodiments, the step in FIG. 5I is followed by this step.

As shown in FIG. 7H, this step follows the step shown in FIG. 7G. In this step, the assembly of the first adhesive layer 120, the curved wires 130, the second adhesive layer 140, and the circuit board 150 is transferred onto the protective cover plate 110 (that is, step S240). In the embodiment shown in FIG. 7H, the aforementioned assembly has the separation film RF1 peeled off and then is transferred onto the protective cover plate 110, having the first adhesive layer 120 attached thereto. The separation film RF3 is attached to the second adhesive layer 140 to protect the second adhesive layer 140.

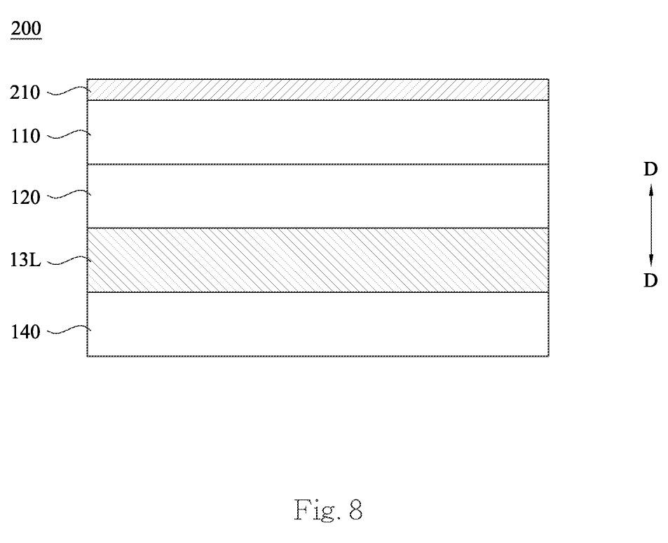

Please refer to FIG. 8, which is a schematic diagram of a touch assembly 200 according to another embodiment of the present disclosure. In the embodiment, as shown in FIG. 8, the touch assembly 200 comprises a protective cover plate 110, a first adhesive layer 120, a wire layer 13L, a second adhesive layer 140, and a visual effect improvement structure 210. The first adhesive layer 120 is disposed on the protective cover plate 110. The thickness of the first adhesive layer 120 ranges from 20 µm to 200 µm. The wire layer 13L comprises curved wires 130 disposed on the first adhesive layer 120. The curved wires 130 are the same as those of the aforementioned embodiments shown in FIG. 1 and FIG. 2, and the aforementioned descriptions thereof can be applied. As described previously, the curved wires 130 comprise a first group of wires G1 extending along a first direction and a second group of wires G2 extending along a second direction and overlapping the first group of wires. Each of the curved wires 130 comprises a conductive inner core 131 and a covering layer 132. The second adhesive layer 140 covers the curved wires 130 and the first adhesive layer 120.

Specifically, in the embodiment, the visual effect improvement structure 210 corresponds to the curved wires 130 in the stacking direction D of the protective cover plate 110 and the wire layer 13L. The visual effect improvement structure 210 is an anti-glare coating (AG) disposed on the protective cover plate 110, more specifically, on one side of the protective cover plate 110 away from the first adhesive layer 120. With the visual effect improvement structure 210 configured in the touch assembly 200, conditions of color lightening and a murky effect, while users are viewing the touch assembly 200, can be effectively improved.

In one or several embodiments, the distinctness of image (DOI) of the visual effect improvement structure 210 is about 0 to 2. In several embodiments, the gloss of the visual effect improvement structure 210 at a 60° angle is about 15 to 35. In several embodiments, the haze of the visual effect improvement structure 210 is about 20 to 40. In several embodiments, the visual effect improvement structure 210 has a transmittance (T%) larger than 88% to light at a 550 nm wavelength. In several embodiments, the arithmetic average roughness (Ra) of the visual effect improvement structure 210 is about 0.5 µm to about 1.1 µm. In some embodiments, the mean width of the profile element (RSm) of the visual effect improvement structure 210 is smaller than about 250 µm.

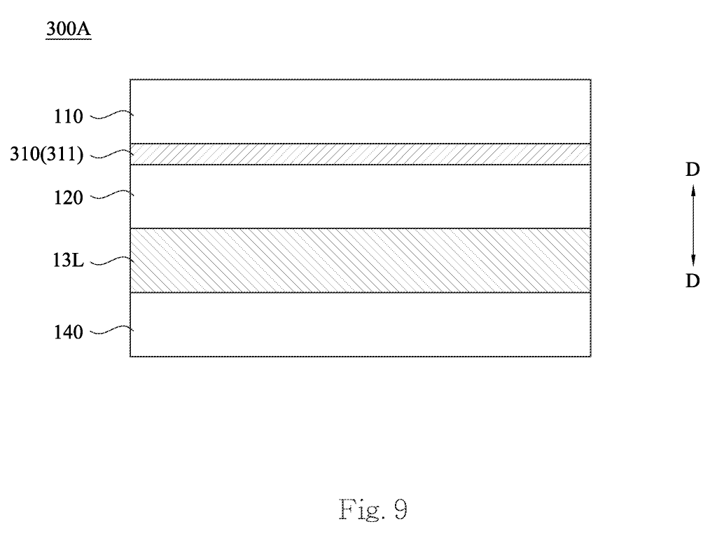

Please refer to FIG. 9, which is a schematic diagram of a touch assembly 300A according to another embodiment of the present disclosure. In the embodiment, as shown in FIG. 9, the touch assembly 300A comprises a protective cover plate 110, a first adhesive layer 120, a wire layer 13L, a second adhesive layer 140, and a visual effect improvement structure 310, wherein the protective cover plate 110, the first adhesive layer 120, the wire layer 13L, and the second adhesive layer 140 are the same as those of the aforementioned embodiment shown in FIG. 8 and, therefore, will not be repeated. In comparison with the embodiment illustrated in FIG. 8, the visual effect improvement structure 310 of this embodiment comprises a polarizing plate 311. The visual effect improvement structure 310 is stacked on one side of the wire layer 13L close to the protective cover plate 110. More specifically, the polarizing plate 311 is stacked between the protective cover plate 110 and the first adhesive layer 120. The polarizing plate 311 transforms ambient light propagating in all directions into polarized light. The polarizing plate 311 can effectively filter glare produced by light being reflected, thus improving visual clarity.

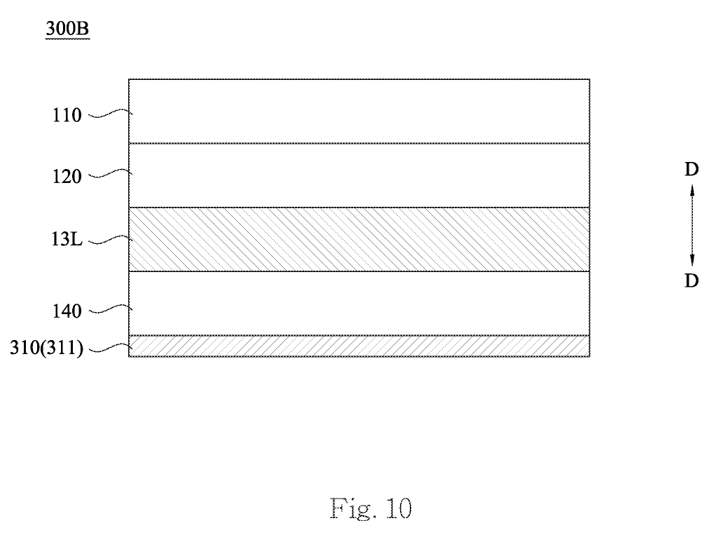

Please refer to FIG. 10, which is a schematic diagram of a touch assembly 300B according to another embodiment of the present disclosure. In the embodiment, as shown in FIG. 10, the touch assembly 300B comprises a protective cover plate 110, a first adhesive layer 120, a wire layer 13L, a second adhesive layer 140, and a visual effect improvement structure 310, wherein the protective cover plate 110, the first adhesive layer 120, the wire layer 13L, and the second adhesive layer 140 are the same as those of the aforementioned embodiment shown in FIG. 9 and, therefore, will not be repeated. In comparison with the embodiment illustrated in FIG. 9, the visual effect improvement structure 310 of this embodiment is instead stacked on one side of the wire layer 13L away from the protective cover plate 110. More specifically, the visual effect improvement structure 310 is stacked on one side of the second adhesive layer 140 away from the wire layer 13L and can still achieve the effect of effectively filtering glare in order to improve visual clarity.

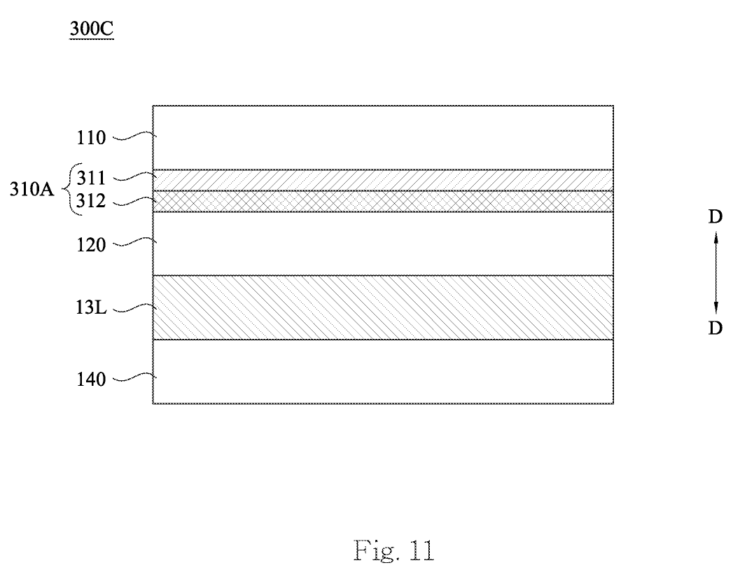

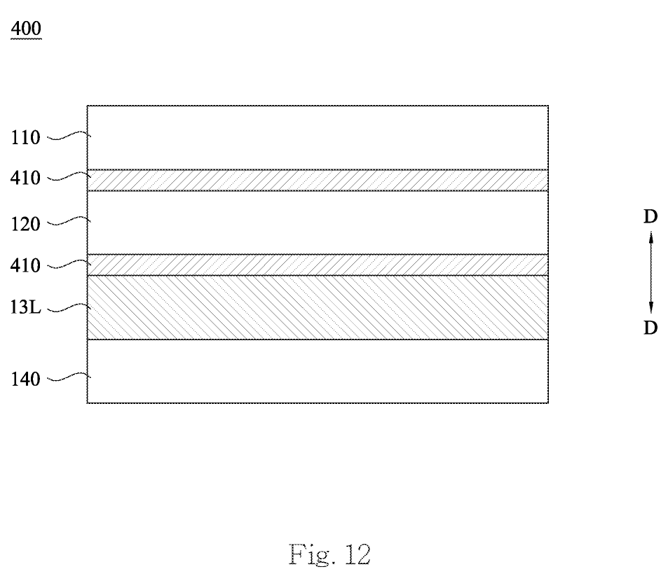

Please refer to FIG. 11, which is a schematic diagram of a touch assembly 300C according to another embodiment of the present disclosure. In the embodiment, as shown in FIG. 10, the touch assembly 300C comprises a protective cover plate 110, a first adhesive layer 120, a wire layer 13L, a second adhesive layer 140, and a visual effect improvement structure 310A, wherein the protective cover plate 110, the first adhesive layer 120, the wire layer 13L, and the second adhesive layer 140 are the same as those of the aforementioned embodiment shown in FIG. 9 and, therefore, will not be repeated. In comparison with the embodiment illustrated in FIG. 9, the visual effect improvement structure 310A of this embodiment further comprises a retarder film 312. The retarder film 312 is disposed on the polarizing plate 311. More specifically, the retarder film 312 is disposed on one side of the polarizing plate 311 away from the protective cover plate 110. Ambient light becomes linear polarized light vibrating in one direction after passing through the polarizing plate 311. The retarder film 312, for example, a 1/4 wavelength plate, can create a 1/4 wavelength phase difference between two vibration components, which are mutually perpendicular, after the light passes therethrough. As a result, the linear polarized light is converted to circularly polarized light. When the wire layer 13L reflects ambient light as it passes through the visual effect improvement structure 310A, the ambient light will be filtered out while re-entering the visual effect improvement structure 310A. The process effectively reduces the reflection of ambient light and increases the contrast ratio of images displayed in the touch assembly 300C.

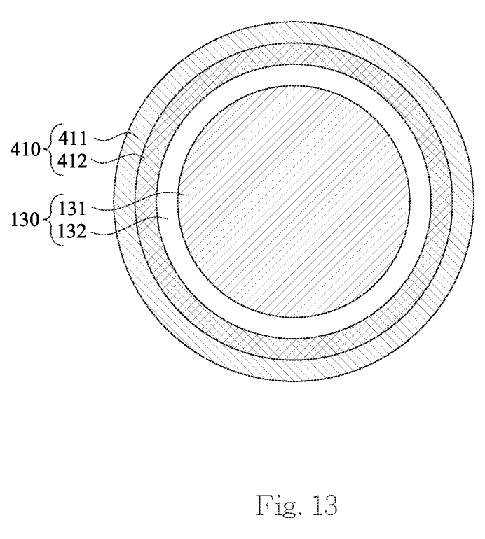

Please refer to FIG. 12 and FIG. 13, where FIG. 12 is a schematic diagram of a touch assembly 400 according to another embodiment of the present disclosure. FIG. 13 is a cross-sectional schematic diagram of the curved wire 130 and the visual effect improvement structure 410 according to an embodiment of the present disclosure. In the embodiment, as shown in FIG. 12 and FIG. 13, the touch assembly 400 comprises a protective cover plate 110, a first adhesive layer 120, a wire layer 13L, a second adhesive layer 140, and a visual effect improvement structure 410, wherein the protective cover plate 110, the first adhesive layer 120, the wire layer 13L, and the second adhesive layer 140 are the same as those of the aforementioned embodiment shown in FIG. 11 and, therefore, will not be repeated. In comparison with the embodiment illustrated in FIG. 11, the visual effect improvement structure 410 of this embodiment comprises a polarizing layer 411 and a retarder film 412. The retarder film 412 is coated outside the covering layer 132 of each curved wire 130. The polarizing layer 411 is coated outside the retarder film 412. The functions of the polarizing layer 411 and the retarder film 412 are the same or similar to the polarizing plate 311 in FIG. 11, respectively, and therefore will not be repeated. Hereby, when the wire layer 13L reflects ambient light as it passes through the visual effect improvement structure 410, the ambient light will be filtered out while re-entering the visual effect improvement structure 410. The process effectively reduces the reflection of ambient light and increases the contrast ratio of images displayed in the touch assembly 400.

According to the aforementioned descriptions of specific embodiments of the present disclosure, it is apparently that, in the touch assembly of the present disclosure, every curved wire comprises a conductive inner core and a covering layer. Therefore, curved wires can be produced by the winding technology in the touch assembly so that the problems of high pollution and high energy consumption that occur during the complex production process of the prior art, which uses indium tin oxide (ITO) as transparent electrodes, can be prevented. By limiting the thickness of the first adhesive layer and the initial tack thereof within a specific range, the problem of jump wire that occurs between the curved wires and the corresponding first adhesive layer during the winding process can be effectively prevented. In the manufacturing method of touch assemblies of the present disclosure, by transferring the assembly of the first adhesive layer, the curved wires, and the second adhesive layer onto the protective cover plate after the step of laminating the second adhesive layer, the problem of damaging the black matrix layer on the protective cover plate caused by the high temperature during the laminating process can be effectively prevented. Furthermore, the gaps among the curved wires can be filled by the first adhesive layer and the second adhesive layer through the method of laminating curved wires between the first adhesive layer and the second adhesive layer. As a result, the visual sense of seeing the curved wires from one side of the second adhesive layer is reduced effectively (that is, reducing the generation of shadows). By having the visual effect improvement structure configured for each of the corresponding curved wires in the touch assembly, the visual sense of seeing mesh patterns in the touch assembly in an environment of high brightness can be effectively resolved.

The above preferred embodiments are presented to disclose the present disclosure and shall not be interpreted to limit the scope, applicability, or configuration of the present disclosure in any way. Those skilled in the art may use any alternative embodiments that are modified or changed without departing from the spirit and scope of the present disclosure and shall be included in the appended claims.

### COMPONENT SYMBOL

100, 200, 300A, 300B, 300C, 400: Touch assembly

110: Protective cover plate

120: First adhesive layer

13L: Wire layer

130: Curved wire

130A: Enameled wire

131: Conductive inner core

132: Covering layer

140: Second adhesive layer

140A: Hydrogel

150: Circuit board

151: Bonding pad

152: Metal layer

210, 310, 310A, 410: Visual effect improvement structure

311: Polarizing plate

312, 412: Retarder film

411: Polarizing layer

910: Winding machine

920: Glue spreader

930: Welding machine

940: Plate

950: Roller

960: Slitter

D: Stacking direction

EW: Pre-embedded wire

G1: First group of wires

G2: Second group of wires

RF1, RF2, RF3: Separation film

S110, S120, S130, S140, S210, S220, S230, S240: Step

What is claimed is:

1. A touch assembly, comprising:
a protective cover plate;
a first adhesive layer, disposed on the protective cover plate, wherein a thickness of the first adhesive layer is from 20 µm to 200 µm;
a wire layer, comprising a plurality of curved wires disposed on the first adhesive layer, wherein the curved wires comprise a first group of wires extending along a first direction; and a second group of wires extending along a second direction and overlapping the first group of wires, wherein each of the curved wires comprises a conductive inner core and a covering layer;
a second adhesive layer, covering the curved wires and the first adhesive layer; and
a visual effect improvement structure, corresponding to each of the curved wires in a stacking direction of the protective cover plate and the wire layer.

2. The touch assembly of claim 1, wherein the visual effect improvement structure is an anti-glare coating layer disposed on the protective cover plate.

3. The touch assembly of claim 1, wherein the visual effect improvement structure comprises a polarizing plate.

4. The touch assembly of claim 3, wherein the visual effect improvement structure is stacked on one side of the wire layer close to the protective cover plate.

5. The touch assembly of claim 3, wherein the visual effect improvement structure is stacked on one side of the wire layer away from the protective cover plate.

6. The touch assembly of claim 3, wherein the visual effect improvement structure further comprises a retarder film, disposed on the polarizing plate.

7. The touch assembly of claim 1, wherein each of the curved wires is an enameled wire.

8. The touch assembly of claim 1, wherein the visual effect improvement structure comprises a polarizing layer; and the polarizing layer is coated outside the covering layer of each of the curved wires.

9. The touch assembly of claim 8, wherein the visual effect improvement structure further comprises a retarder film; and the retarder film is coated outside the covering layer of each of the curved wires and the polarizing layer is coated outside the retarder film.

10. The touch assembly of claim 1, wherein a material of the covering layer is selected from the group consisting of polyvinyl formal, polyurethane, polyamide, polyester, polyester-polyimide, polyamide-polyimide, polyimide, and a combination thereof.
